(19) United States
(12) Patent Application Publication
(10) Pub. No.: US 2018/0183511 A1
(43) Pub. Date: Jun. 28, 2018

(54) FREQUENCY-SHARING RADIO COMMUNICATION SYSTEM AND SATELLITE TERMINAL

(71) Applicant: Mitsubishi Electric Corporation, Chiyoda-ku (JP)

(72) Inventors: Masao OGA, TOKYO (JP); KEIJIRO TAKE, TOKYO (JP)

(73) Assignee: Mitsubishi Electric Corporation, Chiyoda-ku (JP)

(21) Appl. No.: 15/129,286

(22) PCT Filed: Jan. 21, 2015
(86) PCT No.: PCT/JP2015/000242

§ 371 Date: Sep. 26, 2016

(30) Foreign Application Priority Data
Mar. 31, 2014 (JP) 2014-071797

(51) Int. Cl. H04B 7/185; H04B 7/155; H04W 16/14

(52) U.S. Cl. CPC H04B 7/18513; H04W 88/08; H04W 16/14; H04B 7/155

(57) ABSTRACT

A frequency-sharing radio communication system that includes a terrestrial radio communication system and a satellite communication system and in which a frequency band of a radio wave used by a terrestrial base station and a radio terminal of the terrestrial radio communication system overlaps with a frequency band of a beam radiated from a satellite of the satellite communication system, includes: a monitoring device that stores management information that associates a frequency used by the terrestrial base station, the usage state of the frequency, and a frequency of the beam radiated to an area where the terrestrial base station is located; and a managing device that selects, based on the management information, the terrestrial base station that shares a frequency with the beam and is located within an irradiation range of the beam, and instructs the selected terrestrial base station to stop using the shared frequency.

### FIELD

The present invention relates to a technology that allows a terrestrial radio communication system and a satellite communication system to share a frequency.

### BACKGROUND

Attention has recently been given to communication methods that are used, for example, for reliably confirming safety and transmitting information in the event of large-scale disasters, such as earthquakes and tsunamis. A satellite communication service is a communication method that is less vulnerable to disasters or the like; however, the frequency bandwidth used in a satellite communication system is typically narrow; therefore, there is a limitation on the number of communication lines that can be ensured at the same time. Moreover, a satellite communication service cannot provide high-capacity nor high-speed communication. Consequently, for example, when communication concentration occurs due to a disaster, it is difficult to provide stable communication to many users.

A method proposed for solving such a situation is for two different communication systems to share a frequency band. For example, an inhibit-signal transmission apparatus is disclosed in Patent Literature 1. In a decoding system that includes an existing communication system (for example, a satellite communication system) and a new communication system (for example, a mobile phone system) that share the frequency band, the inhibit-signal transmission apparatus is disposed near the receiver in the existing communication system to monitor the frequency used in the existing communication system, and it transmits by radio an inhibit signal to the base station or terminals in the new communication system to inhibit the new communication system from using the frequency that is being used.

### CITATION LIST

### Patent Literature

Patent Literature 1: Japanese Patent Application Laid-open No. 2009-111968 (FIG. 1)

### SUMMARY

### Technical Problem

Development of a satellite communication method referred to as a multi-beam method or multi-spot-beam method has been in progress for the satellite communication systems. With this method, the irradiation range (spot) of a radio wave (beam) to be transmitted is limited to a certain range and a plurality of beams are used to cover the whole service area of the satellite communication system. A satellite communication system using a multi-beam method uses different frequencies for adjacent spots.

In a frequency-sharing radio communication system that uses the conventional frequency sharing method described above, an inhibit signal is transmitted from the inhibit-signal transmission apparatus to the base station or terminals in the existing communication system. In a case where a satellite communication system that uses the multi-beam method described above is the existing communication system and, for example, a mobile phone system is the new communication system, because an inhibit signal does not recognize the boundaries between spots of the satellite communication system, the inhibit signal transmitted for the frequency detected in one spot reaches a different spot that uses a different frequency. At this point in time, if the mobile phone system is using the frequency specified by the inhibit signal within the range of this different spot, even if the satellite communication system uses a frequency that is different from that specified by the inhibit signal, the use of this frequency is inhibited in the mobile phone system. This poses a problem in that the frequency use efficiency is reduced.

The present invention has been achieved in view of the above problems and an object of the present invention is to improve the frequency use efficiency in a frequency-sharing radio communication system in which a satellite communication system using a multi-beam method and a terrestrial radio communication system share a frequency band.

### Solution to Problem

A frequency-sharing radio communication system according to an aspect of the present invention is a frequency-sharing radio communication system that includes a terrestrial radio communication system and a satellite communication system and in which a frequency band of a radio wave used by a terrestrial base station and a radio terminal of the terrestrial radio communication system overlaps with a frequency band of a radio wave (hereinafter, referred to as a beam) radiated from a satellite of the satellite communication system, the frequency-sharing radio communication system including: a monitoring device that stores management information in which a frequency used by the terrestrial base station, an usage state of the frequency, and a frequency of the beam radiated to an area where the terrestrial base station is located are associated with each other; and a managing device that selects, on a basis of the management information acquired from the monitoring device, the terrestrial base station that shares a frequency with the beam of the satellite communication system and is located within an irradiation range of the beam, and gives an instruction to stop using the shared frequency to the selected terrestrial base station.

A satellite terminal according to another aspect of the present invention is a satellite terminal that is installed in a terrestrial base station of a terrestrial radio communication system that is used in a frequency-sharing radio communication system that includes the terrestrial radio communication system and a satellite communication system and in which a frequency band of a radio wave used by a terrestrial base station and a radio terminal of the terrestrial radio communication system overlaps with a frequency band of a radio wave (hereinafter, referred to as a beam) radiated from a satellite of the satellite communication system, the satellite terminal including: an M2M functional unit that acquires a frequency used by the terrestrial base station and a usage state of the used frequency from the installed terrestrial base station; and an antenna that outputs a radio wave for transmitting a satellite radio signal that includes the used frequency and the usage state of the frequency that are acquired by the M2M functional unit.

### Advantageous Effects of Invention

According to the present invention, a terrestrial radio communication system that is located in a spot (irradiation range) of a beam used by a satellite communication system is inhibited from using the frequency of the beam and a terrestrial radio communication system that is located in a spot of a beam that uses a frequency that is different from that of the aforementioned beam can use the inhibited frequency; therefore, the frequency use efficiency in a frequency-sharing radio communication system can be improved.

### BRIEF DESCRIPTION OF DRAWINGS

FIG. 1 is a block diagram illustrating one example configuration of a frequency-sharing radio communication system according to a first embodiment of the present invention.

FIG. 2 is a schematic diagram illustrating an example of the installation position of a satellite dedicated terminal according to the first embodiment.

FIG. 3 is a block diagram illustrating an example configuration of a mobile base station and the satellite dedicated terminal according to the first embodiment.

FIG. 4 is a sequence diagram illustrating an example of a procedure for reporting the state of the mobile base station to a monitoring device according to the first embodiment.

FIG. 5 is a table illustrating one example of information included in the mobile base station state according to the first embodiment.

FIG. 6 is a table illustrating one example of management information stored in the monitoring device according to the first embodiment.

FIG. 7 is a sequence diagram illustrating an example of a procedure for reporting the state of the mobile base station to the monitoring device according to the first embodiment.

FIG. 8 is a sequence diagram illustrating an example of a procedure by which the managing device acquires the state of the mobile base station when a disaster occurs according to the first embodiment.

FIG. 9 is a flowchart illustrating the flow of a process performed by the managing device when a disaster occurs according to the first embodiment.

FIG. 10 is a table illustrating one example of the management information stored in the monitoring device when a disaster occurs according to the first embodiment.

FIG. 11 is a flowchart illustrating the flow of a service stop process performed by the mobile base station according to the first embodiment.

FIG. 12 is a sequence diagram explaining one example of a procedure by which the managing device acquires the state of the mobile base station when a disaster occurs according to the first embodiment.

FIG. 13 is a schematic diagram illustrating a mobile base station in which the use of a frequency is stopped and a mobile base station in which the use of a frequency is not stopped in the frequency-sharing radio communication system according to the first embodiment.

FIG. 14 is a schematic diagram illustrating the rearrangement of beams due to the reconstruction of radio resources for satellite communication when a disaster occurs.

FIG. 15 is a block diagram illustrating a modified configuration of the mobile base station and the satellite dedicated terminal in the frequency-sharing radio communication system according to the first embodiment.

### DESCRIPTION OF EMBODIMENTS

Exemplary embodiments for implementing the present invention will be explained below with reference to the drawings. This invention is not limited to the embodiments. Although the following description will be made on the assumption that a mobile phone system with specifications defined by, for example, 3GPP (3rd Generation Partnership Project) is used as a terrestrial radio communication system, the present invention is not limited thereto. Other terrestrial radio communication systems may also be used. The satellite communication system in the following description uses a multi-beam method in which a plurality of radio waves (satellite beams) are used and the irradiation ranges (spots) of the satellite beams are combined to cover the whole service area of the satellite communication system.

In the drawings referred to in the following description, the same or equivalent parts are designated by the same reference numerals.

### FIRST EMBODIMENT

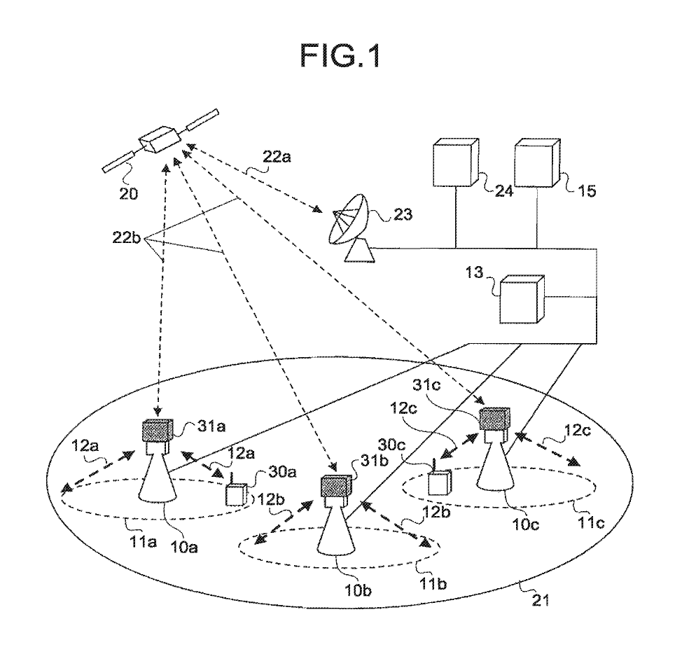

FIG. 1 is a block diagram illustrating one example configuration of a frequency-sharing radio communication system according to a first embodiment of the present invention in which a satellite communication system and a terrestrial radio communication system share a frequency. In FIG. 1, signals transmitted from mobile base stations 10 (10a to 10c) generate service areas 11 (11a to 11c) of a mobile phone system. In the example in FIG. 1, the mobile base station 10a and a mobile terminal 30a are connected by a terrestrial radio signal (mobile signal) 12a of the mobile phone system and the mobile base station 10c and a mobile terminal 30c are connected by a mobile signal 12c.

Mobile terminals 30 may be radio terminals that can be used both in the mobile phone system and the satellite communication system or terminals dedicated to the respective communication systems may be used.

A managing device 15 manages the frequency shared by the mobile phone system and the satellite communication system. Core network (CN) equipment 13 is equipment that performs call control between the mobile base stations 10 and the mobile terminals 30 and relays communication between the managing device 15 and the mobile base stations 10. The core network equipment 13 in the present embodiment also performs call control between a satellite base station 23 and satellite dedicated terminals (satellite terminals) 31, which will be described later, and relays communication between a monitoring device 24 and the satellite base station 23, which will be described later; however, the core network (CN) equipment 13 may include different devices provided for the respective communication systems.

In the satellite communication system, a radio wave (satellite beam) transmitted from a satellite 20 generates a service area 21 of the satellite communication system, and the satellite 20 and the satellite base station 23, which is a terrestrial base station of the satellite communication system, are connected by a satellite radio signal (satellite signal) 22a through a feeder link. The satellite dedicated terminals 31 (31a to 31c) are connected to the satellite 20 by the satellite radio signal 22b through a service link. The satellite dedicated terminal 31 is disposed near the mobile base station 10; specifies the satellite beam at the mobile base station 10; and monitors the operational state of the mobile base station 10. In the following description, the satellite dedicated terminals 31 are also referred to as M2M (Machine-to-Machine) terminals.

In the frequency-sharing radio communication system according to the present embodiment, the frequency bands of the radio waves for transmitting the terrestrial radio signals 12 of the mobile phone system overlap with the frequency band of the radio wave (satellite beam) for transmitting the satellite radio signal 22b through a service link of the satellite communication system. In other words, the mobile phone system and the satellite communication system share a frequency.

On the basis of the operational state of the mobile base stations 10 reported from the satellite dedicated terminals 31 via the satellite 20 and the satellite base station 23, the monitoring device 24 stores information on the satellite beam and the frequencies used in the mobile base stations 10 in order to monitor the usage state of the frequencies in each system and provides these pieces of information to the managing device 15.

The present invention does not limit an interconnection method necessary for interconnecting the core network equipment 13, the managing device 15, the mobile base stations 10, the satellite base station 23, and the monitoring device 24. For example, they may be interconnected by an IP (Internet Protocol) network. In the present embodiment, they are interconnected by an IP network.

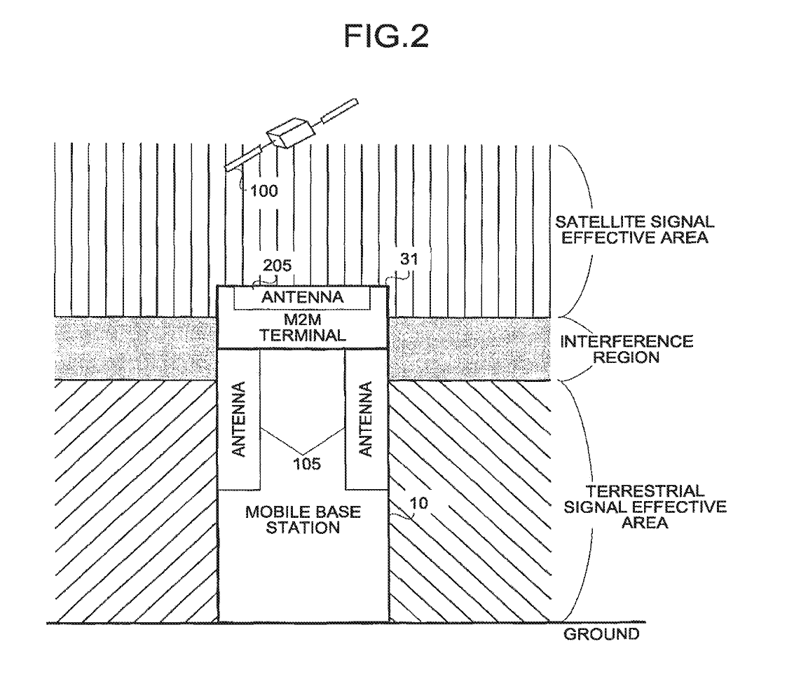

FIG. 2 is a schematic diagram illustrating an example installation of the satellite dedicated terminal 31 in the mobile base station 10 according to the present embodiment. When the mobile signal 12 and the satellite signal 22b use the same frequency, the radio waves interfere with each other and thus the communication quality degrades. In particular, with the satellite signal that the satellite dedicated terminal 31 receives from the satellite 20, satellite communication cannot be performed due to strong interference from the signal transmitted from the mobile base station 10. For this reason, in this example, the satellite dedicated terminal 31 is installed in the upper portion where the signal from the mobile base station 10 does not reach, thereby separating the signal effective area of the mobile base station 10 from a signal effective 301 for satellite communication. An antenna 205 of the satellite dedicated terminal 31 is installed, for example, in the upper portion of the satellite dedicated terminal 31 taking into account the directionality of an antenna 105 of the mobile base station 10 and the interference region that is generated at the boundary between the effective areas. Because the satellite 20 receives radio waves transmitted from the mobile terminals 30, the radio wave of the satellite signal 22b and the radio waves of the mobile signals 12 may interfere with each other. A possible measure against this is to design the system such that the transmission output of the satellite dedicated terminals 31 is significantly larger than the transmission output of the mobile terminals 30.

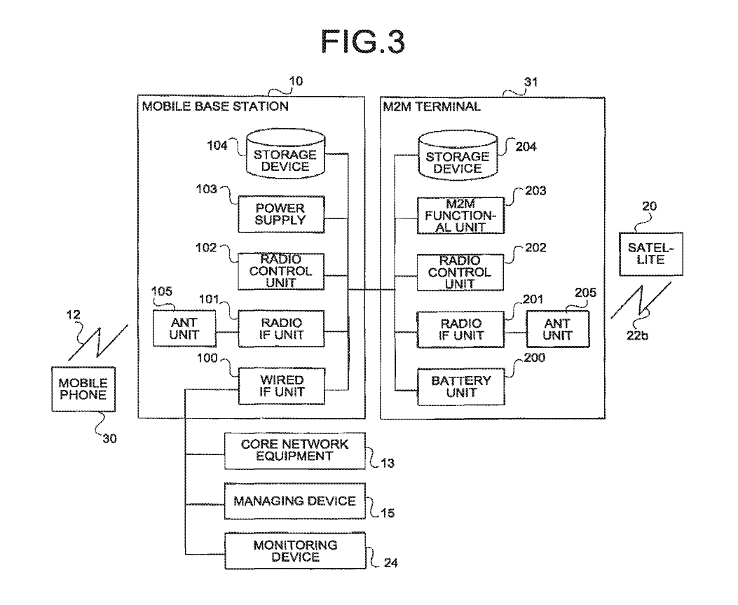

FIG. 3 is a block diagram illustrating an example configuration of the mobile base station 10 and the satellite dedicated terminal 31 according to the present embodiment. The mobile base station 10 has a configuration similar to the configuration of a base station of a typical mobile phone system. Specifically, the mobile base station 10 includes the core network equipment 13; the managing device 15; a wired IF (interface) unit 100 for connecting to the monitoring device 24; the ANT unit (antenna) 105 for transmitting and receiving a radio wave of the mobile signal 12 to and from the mobile terminal 30; a radio IF unit 101, which performs a process of transmitting and receiving the mobile signal 12; a radio control unit 102, which controls the radio to obtain a radio connection; a power supply 103, which supplies power to the mobile base station 10; and a storage device 104, which stores internal information necessary for operating the mobile base station 10.

The satellite dedicated terminal 31 includes a battery unit 200, which supplies power to the satellite dedicated terminal 31; an ANT unit (antenna) 205 for transmitting and receiving a radio wave of the satellite signal 22b to and from the satellite 20; a radio IF unit 201, which performs a process of transmitting and receiving the satellite signal 22b; a radio control unit 202, which performs controls to obtain a radio connection for satellite communication; an M2M functional unit 203, which has a function of periodically acquiring, from the radio control unit 102 of the mobile base station 10, information on a frequency to be used and the usage state of the frequency as the operational state of the mobile base station 10, and reporting it to the monitoring device 24 via the satellite 20; and a storage device 204, which stores information on the mobile base station 10, information on the satellite beam that is present, and internal information necessary for operating the satellite dedicated terminal 31. The battery unit 200 may be used as an emergency power supply for disasters or the like and power may be supplied to the satellite dedicated terminal 31 by other methods in normal conditions. For example, power may be supplied to the satellite dedicated terminal 31 from the power supply 103 of the terrestrial mobile base station in normal conditions.

The monitoring device 24 and the managing device 15 can be realized by a computer (server device) that includes a processor, a storage device, and peripheral circuits, such as a memory, and a program executed on the processor.

In the present embodiment, information on the frequencies used in the mobile base station 10 and other information are acquired from the radio control unit 102 of the mobile base station 10; however, information stored in the storage device 104 may be acquired. The present invention does not limit a method of connecting the mobile base station 10 and the satellite dedicated terminal 31. Various connection methods can be considered as a method of connecting the mobile base station 10 and the satellite dedicated terminal 31, such as a general interface, an example of which is a USB (Universal Serial Bus), and a dedicated interface.

Next, an explanation will be given of an operation of the frequency-sharing radio communication system according to the present embodiment. First, an explanation will be given of a process performed by the monitoring device 24 for collecting the operational state of the mobile base station 10 from the satellite dedicated terminal 31. There are two kinds of procedures by which the monitoring device 24 collects the operational state of the mobile base station 10, i.e., a procedure in which the satellite dedicated terminal 31 takes the initiative to report the operational state of the mobile base station 10 to the monitoring device 24; and a procedure in which the monitoring device 24 takes the initiative to request the satellite dedicated terminal 31 to report the operational state of the mobile base station 10 and the satellite dedicated terminal 31 that has received the request reports the operational state to the monitoring device 24.

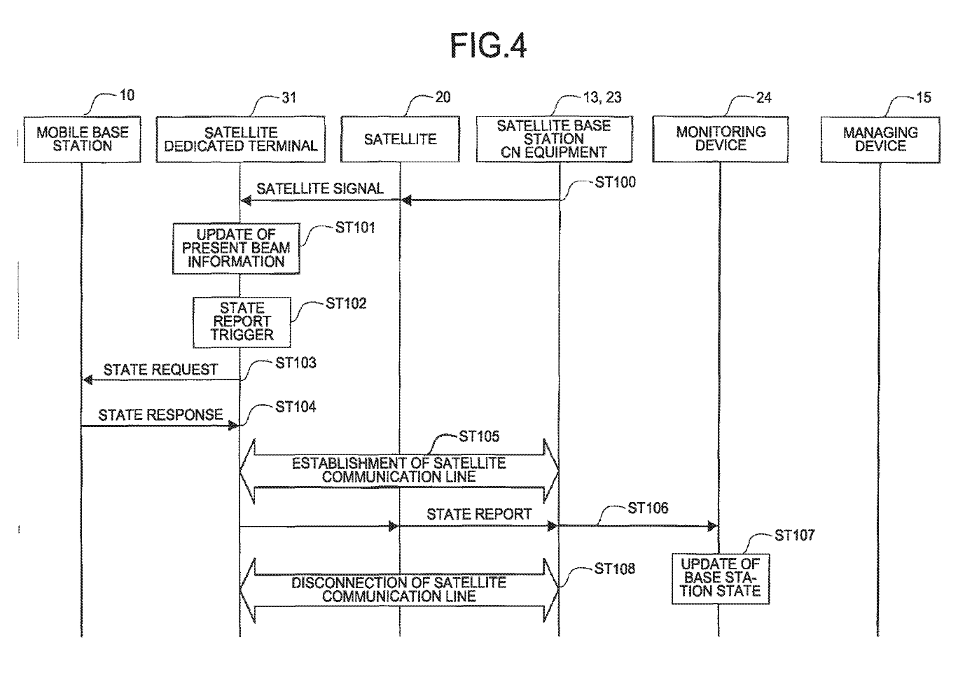

FIG. 4 is a sequence diagram illustrating a procedure in which the satellite dedicated terminal 31 takes the initiative to report the operational state to the monitoring device 24. With regard to the procedure performed between the core network equipment 13 and the satellite base station 23, it is satisfactory if the procedure defined for each satellite communication system to which the present invention is applied is used and thus this procedure is omitted from the sequence diagram illustrated in FIG. 4. The procedure performed between the core network equipment 13 and the satellite base station 23 is also omitted from other sequence diagrams that are referred to in the following description.

First, when the satellite dedicated terminal 31 receives a satellite signal from the satellite 20 (ST100), the radio control unit 202 acquires satellite beam information from the system information included in the satellite signal and stores the satellite beam information in the storage device 204 as present beam information (update of the present beam information) (ST101). The satellite beam information included in the satellite signal is information indicating the frequency and the bandwidth of the satellite beam radiated from the satellite.

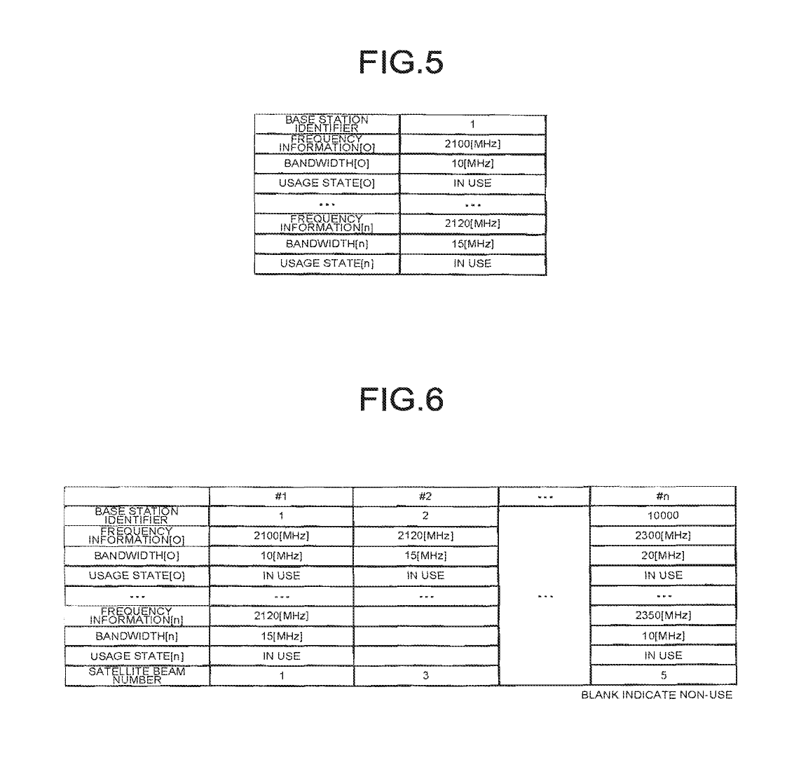

The M2M functional unit 203 of the satellite dedicated terminal 31 stores, in the storage device 204, the timer value that defines the period with which the operational state of the mobile base station 10 is acquired. The M2M functional unit 203 uses, as a trigger (state report trigger), expiration of the state acquisition timer that occurs every period of the timer value (ST102) to request (state request), from the mobile base station 10, a notification of the mobile base station state that includes frequencies to be used and the usage state of the frequencies (ST103). The mobile base station 10 transmits the mobile base station state in response to the state request from the satellite dedicated terminal 31 (state response) (ST104). FIG. 5 illustrates one example of the mobile base station state in the present embodiment. The mobile base station state includes a base station identifier attached to each mobile base station to uniquely identify each of the mobile base stations 10; frequencies that can be used in each of the mobile base stations 10 and the bandwidths of the frequencies; and the usage state of the usable frequencies.

In order to establish a satellite communication line between the satellite dedicated terminal 31 and the satellite base station 23 via the satellite 20, the radio control unit 202 in the satellite dedicated terminal 31 that has received the mobile-base-station-state response performs a call connection with the satellite base station 23 and the core network equipment 13 (ST105). After the satellite communication line is established, the M2M functional unit 203 in the satellite dedicated terminal 31 transmits, to the monitoring device 24, a state report that includes the satellite beam information and the mobile base station state acquired from the mobile base station 10. The state report is sent to the monitoring device 24 via the satellite 20, the satellite base station 23, and the core network equipment 13 (ST106).

The monitoring device 24 that has received the state report updates the management information stored therein on the basis of the received state report (update of the base station state) (ST107). FIG. 6 illustrates one example of the management information stored in the managing device 24. The management information in this example stores the base station identifier of the mobile base stations 10 in which the satellite dedicated terminals 31 are disposed; frequencies that can be used by the mobile base stations associated with the base station identifier; the bandwidths of the frequencies; the usage state of the frequencies; and information on the satellite beams in which the mobile base stations 10 are present. In this example, the satellite beam information is represented by numbers (satellite beam numbers). The frequency that is used by a satellite beam and the band of the frequency can be derived from the satellite beam number.

Upon completion of the state report to the monitoring device 24 by performing the process at ST106, a process is performed to disconnect the satellite communication line that as established by the process at ST105 between the radio control unit 202 of the satellite dedicated terminal 31, the satellite base station 23, and the core network equipment 13 (ST108).

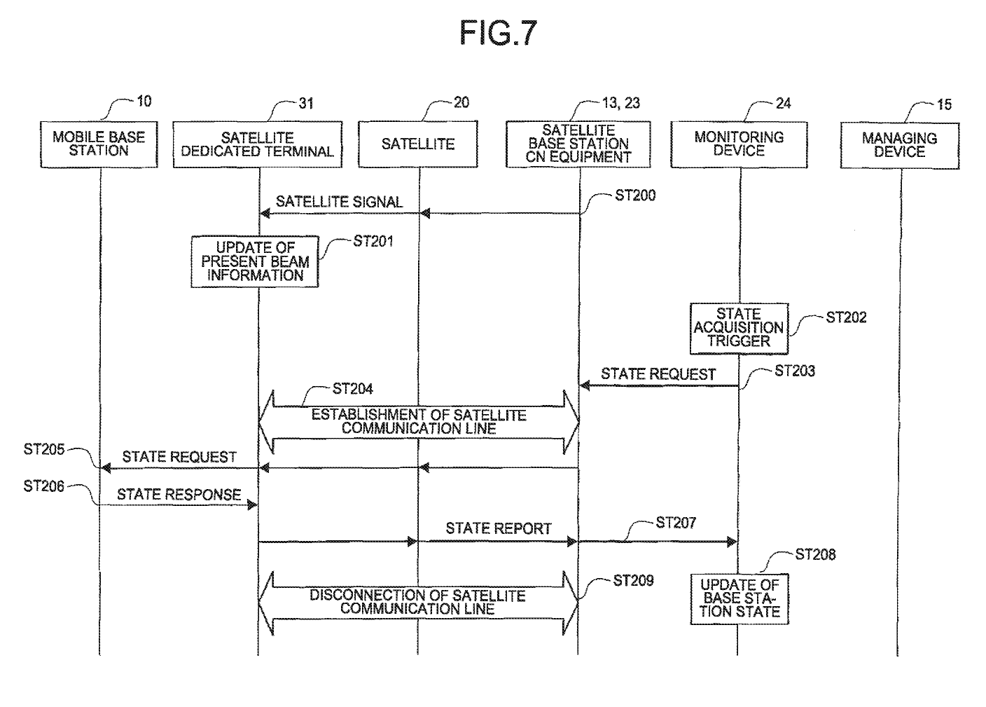

FIG. 7 is a sequence diagram illustrating a procedure in which the monitoring device 24 takes the initiative to acquire the mobile base station state. The processes at ST200 and ST201 in FIG. 7 are similar to those at ST100 and ST101 illustrated in FIG. 4.

In a similar manner to the satellite dedicated terminal 31, the monitoring device 24 stores therein the timer value that defines the period with which the operational state of the mobile base station 10 is acquired. The monitoring device 24 uses, as a trigger (state acquisition trigger), expiration of the state acquisition timer that occurs every period of the timer value (ST202) to transmit, to the core network equipment 13, the state request to request the state report including the mobile base station state and the satellite beam information from the satellite dedicated terminal 31 (ST203). The core network equipment 13 that has received the state request performs a call connection to establish a satellite communication line connected to the satellite dedicated terminal 31 via the satellite base station 23 and the satellite 20 (satellite communication line establishment) (ST204).

After the satellite communication line is established, the core network equipment 13 transmits the state request received from the monitoring device 24 to the satellite dedicated terminal 31. The M2M functional unit 203 in the satellite dedicated terminal 31 that has received the state request requests the mobile base station state including frequencies to be used and the usage state of the frequencies from the mobile base station 10 (ST205). The mobile base station 10 that has received the state request transmits the mobile base station state to the satellite dedicated terminal 31 (state response) (ST206).

The subsequent processes at ST207 to ST209 are similar to the processes at ST107 to ST109 explained with reference to FIG. 4.

As described above, with the procedure in FIG. 4 or FIG. 7, the monitoring device 24 can periodically acquire the mobile base station state of the mobile base station 10 and the satellite beam information on the spot of the satellite communication system in which the mobile base station 10 is located.

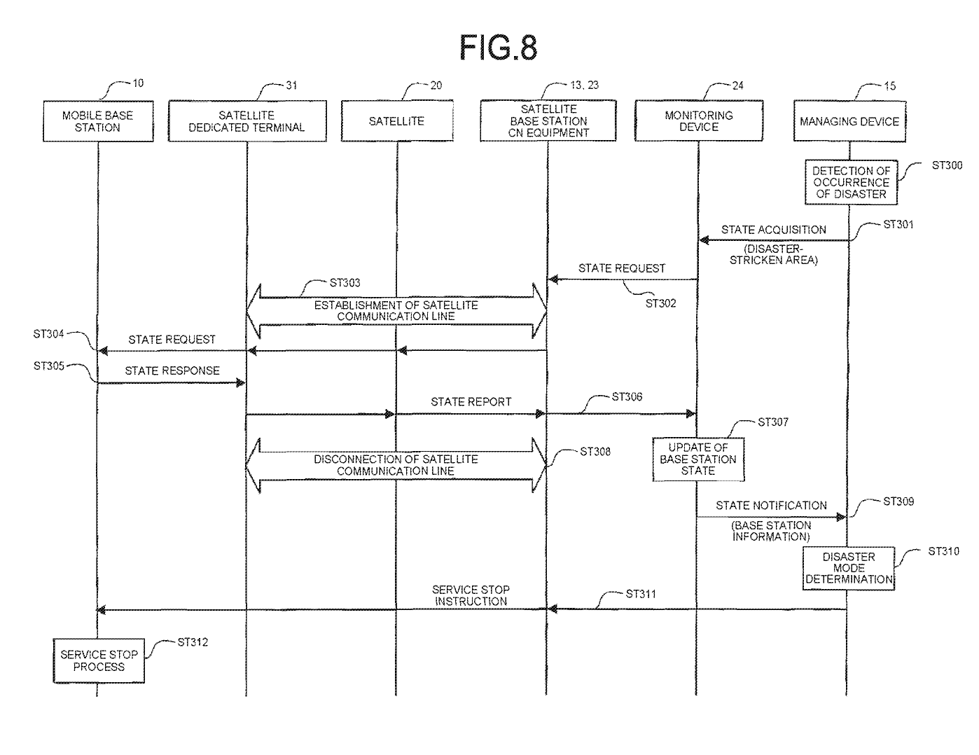

Next, an explanation will be given of an operation performed by the managing device 15 for inhibiting the mobile phone system from using the frequency that is used in the radio communication system, for example, in case of a disaster. FIG. 8 is a sequence diagram illustrating the procedure of this operation. An explanation will be given here of an example of a process that is triggered by the occurrence of a disaster.

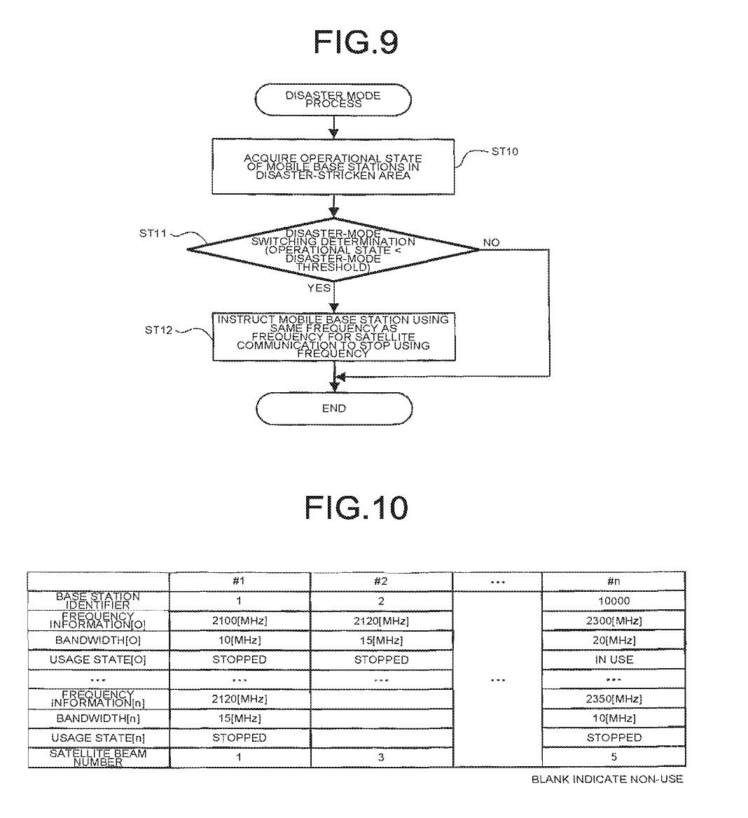

When the managing device 15 detects the occurrence of a disaster in a certain area (ST300), the managing device 15 starts the disaster mode process illustrated in the process flow in the flowchart in FIG. 9. The managing device 15 acquires the operational state of the mobile base stations 10 in the area (disaster-stricken area) where the disaster occurs (ST10). With the process at ST10, the managing device 15 specifies the satellite beam number of the satellite beam that is radiated to the spot in the disaster-stricken area and requests the monitoring device 24 to acquire the operational state of the mobile base stations 10 in the disaster-stricken area (state acquisition) (ST301). It is assumed that the managing device 15 recognizes the satellite beam number of the satellite communication system and the graphical position of the spot irradiated with the satellite beam corresponding to the satellite beam number.

The monitoring device 24 that has received the state acquisition transmits, to the core network equipment 13, the state requests that are to be made to the satellite dedicated terminals 31. The subsequent processes ST302 to ST308 are similar to the processes at ST203 to ST209 explained with reference to FIG. 7. It is desirable that the state requests that are made to the satellite dedicated terminals 31 in a disaster-stricken area are scheduled such that they are distributed in time in order to avoid congestion of the satellite lines. It may not be necessary to request the state of any mobile base station that does not use the frequency information specified by the specified satellite beam number on the basis of the latest base station state in the management information stored in the monitoring device 24.

FIG. 10 illustrates one example of the management information at the time of a disaster that is updated by the monitoring device 14 in the process at ST307. The mobile base station 10 in which the usage state indicates “stopped” has stopped using the corresponding frequency band, for example, because the station is damaged. The usage state that indicates “in use” indicates that the frequency corresponding thereto is continuously in use in the mobile base station 10. When the monitoring device 24 completes the state acquisition from all the satellite dedicated terminals 31 to which the request for the state acquisition is made, the monitoring device 24 transmits, to the managing device 15, the management information on the mobile base stations that are in a disaster-stricken area and to which the request for the state acquisition is made in the process at ST301 as a state notification (Step ST309).

The managing device 15 that has received the state notification detects the number of mobile base stations 10 that are in a disaster-stricken area and in which the usage state indicates “stopped”; compares the number of mobile base stations 10 with a disaster-mode switching threshold, which is a reference for determining the scale of the disaster; and performs a determination process for determining whether to switch to the disaster mode (ST310). The process at ST310 in the sequence diagram corresponds to the disaster-mode switching determination at ST11 in the process flow illustrated in FIG. 9. When the managing device 15 determines that the mode is to be switched to the disaster mode, the managing device 15 selects the mobile base station 10 that uses the same frequency as the frequency of the satellite beam used in the spot in the satellite communication system corresponding to the disaster-stricken area on the basis of the state notification received from the monitoring device 24. The managing device 15 then transmits, to the selected mobile base station 10, a service stop instruction to instruct the mobile base station 10 to stop using the frequency (ST311 in the sequence diagram and ST12 in the process flow). The service stop instruction is transmitted by identifying, by the base station identifier in 10, the mobile base station 10 to which the service stop instruction is to be transmitted. Then, the mobile base station 10 that has received the service stop instruction from the managing device 15 performs a service stop process (ST312).

In the above manner, when the mobile phone system is functioning satisfactorily, for example, it is possible to control the mobile phone system such that it continuously uses the frequency that is used by the satellite communication system.

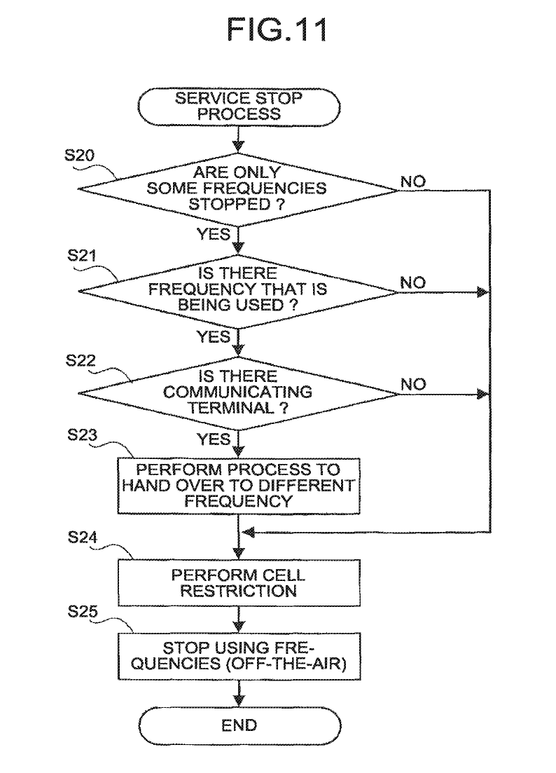

FIG. 11 is a flowchart illustrating details of the process flow of the service stop process performed by the mobile base station 10. The mobile base station 10 that has received the service stop instruction from the managing device 15 first checks whether stopping the specified frequency corresponds to stopping all the frequencies that are used (S20). When all the frequencies that are used are stopped (No at S20), the mobile base station 10 transmits, to the service area 11 of the mobile base station, system information in which a cell restriction is set (S24). The mobile terminal 30 that has received the system information reselects a cell, i.e., a different mobile base station 10 or a different communication system. After the mobile base station 10 continues to transmit the system information on the cell restriction for a fixed period of time at S24, the use of all the frequencies is stopped (off-the-air) (S25).

In contrast, when the frequency that is indicated to stop does not correspond to all the frequencies that are used (Yes at S20), the mobile base station 10 checks the usage state of the frequencies other than the frequency that is indicated to stop (S21). When there is a frequency that is being used and is among the frequencies that are not indicated to stop, (Yes at S21), the mobile base station 10 checks whether there is the mobile terminal 30 that is communicating at the frequency indicated to stop (S22). When there is the mobile terminal 30 that is communicating at the frequency indicated to stop (Yes at S22), the mobile base station 10 causes the communicating mobile terminal 30 to be handed over to a cell that uses a frequency that is being used and is not indicated to stop (S23). Thereafter, the mobile base station 10 performs a cell restriction process (S24) on the cell that uses the frequency that is indicated to stop and stops using the indicated frequency (off-the-air) (S25) in a similar manner to the case when the use of all the frequencies is stopped. When No is determined at S21 and when No is determined at S22, the processes at S24 and S25 are performed in a similar manner.

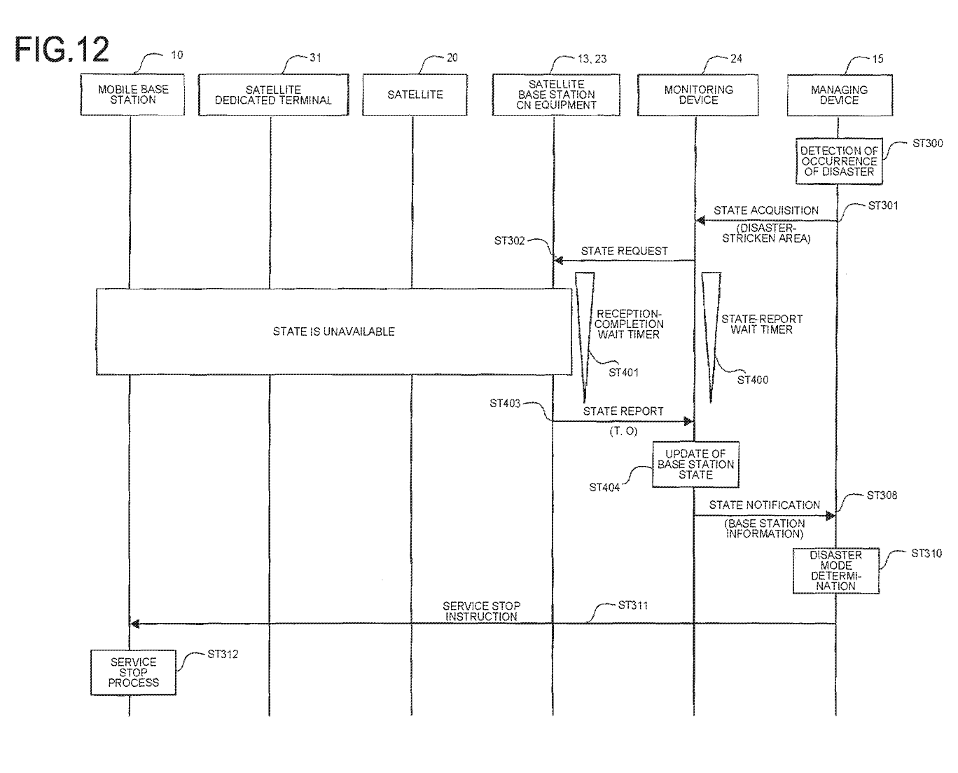

An explanation has been given of the operation when the operational state of the mobile base system has been successfully acquired. An explanation will be given next of an operation when acquisition of the operational state has failed. FIG. 12 is a sequence diagram explaining the operation procedure in a case when the process of acquiring the operational state of the mobile base station is not completed successfully because of the collapse or the like of the mobile base station 10. In FIG. 12, the processes denoted by the same reference numerals as those in FIG. 8 are similar to those explained in FIG. 8. The monitoring device 24 that has transmitted the state request to the core network equipment 13 starts counting performed by the state-report wait timer, which functions as a protection timer, until a state response is received (ST400). Moreover, the core network equipment 13 that has received the state request starts counting performed by the reception-completion wait timer, which functions as a protection timer, until a satellite communication line is established (ST401).

When the satellite dedicated terminal 31 is unable to communicate or when a satellite communication line is not established and thus the operational state cannot be acquired, the reception-completion wait timer count expires (T.O in FIG. 12) and the core network equipment 13 that has detected a failure to acquire the operational state due to a failure to establish a satellite communication line transmits, to the monitoring device 24, the state report in which a state acquisition failure is set (ST403). The monitoring device 24 that has received the state report determines that all the frequencies have stopped in the mobile base station 10 corresponding to this state report and updates the management information (ST404).

The subsequent processes are similar to the processes in the procedure in FIG. 8. By using this procedure, even when the operational state cannot be acquired, the state of the mobile base station 10 can be appropriately updated. This procedure can be changed as appropriate. For example, the satellite base station 23 can detect a failure to establish a satellite communication line.

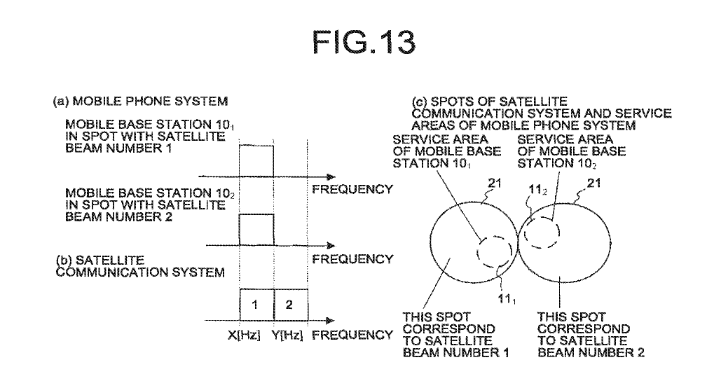

FIG. 13 is a schematic diagram illustrating an example of the relationship between frequencies that are used and the arrangement of the spots of the satellite communication system and the service areas of the mobile base stations in the frequency-sharing communication system according to the present embodiment. As illustrated in FIG. 13(c), there are a spot in which a beam with the satellite beam number 1 is used and a spot in which a beam with the satellite beam number 2 is used, and the spots include the service area 11 of a mobile base station 10₁, a service area 11₁ of a mobile base station 10₁, and a service area 11₂ of a mobile base station 10₂, respectively. As illustrated in FIGS. 13(a) and 13(b), both the mobile base station 10₁ and the mobile base station 10₂ use the frequency X [Hz]. The frequency of the satellite beam number 1 is X [Hz] and the frequency of the satellite beam number 2 is Y [Hz]. The numbers 1 and 2 in FIG. 13(b) indicate the satellite beam numbers.

According to the present embodiment of the present invention, the operation is performed in the above manner; therefore, for example, in case of a disaster, it is possible to instruct the mobile base station 10₁, which is located in the spot with the satellite beam number 1, to stop using the frequency X [Hz] and not to inhibit the mobile base station 10₂, which is located in the spot with the satellite beam number 2, from using the frequency X [Hz].

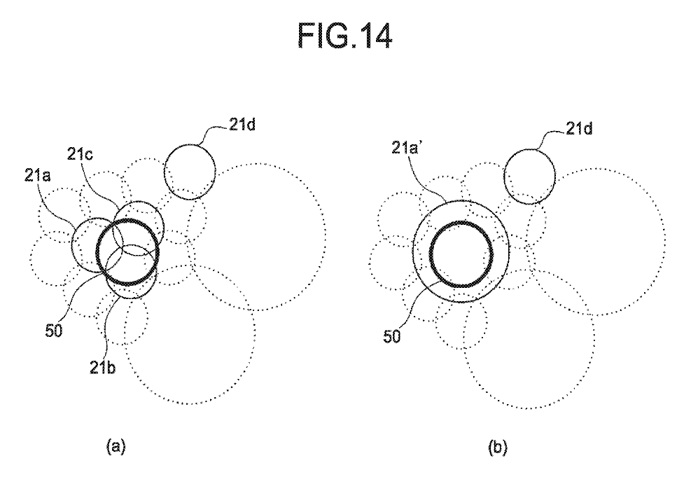

FIG. 14 is a schematic diagram explaining the arrangement of the satellite beams in which radio resources for satellite communication are concentrated in a disaster-stricken area by reconstructing the spots in the satellite communication system in case of a disaster. Solid or dotted circles in FIG. 14 indicate spots. Each spot is formed by one satellite beam and satellite beams forming adjacent spots use different frequencies. Satellite beams forming non-adjacent spots use the same frequency in accordance with the frequency reuse scheme. The circles hatched with thick lines indicate specific areas (referred to as areas 50) that are provided with the service of a specific satellite communication system.

FIG. 14(a) illustrates an example of the satellite beam configuration during normal conditions. It is assumed that there are a spot of a satellite beam 21a (frequency a), a spot of a satellite beam 21b (frequency b), a satellite beam 21c (frequency c), and a spot of a satellite beam 21d (frequency d), and the area 50 is provided with the service of a satellite communication system in the spots of the satellite beams 21a, 21b, and 21c.

FIG. 14(b) illustrates an example of the satellite beam configuration after the spots are reconstructed when a disaster occurs in the area 50. FIG. 14(b) illustrates a case where, in order to concentrate the radio resources of the satellite communication system in the area 50, the satellite beams 21a, 21b, and 21c are reconstructed into a satellite beam 21a′ (frequency a+b+c). When the radio resources of the satellite communication system are concentrated in the area 50, radio resources of other satellite beams can also be used in addition to the satellite beams that are radiated to the disaster-stricken area.

According to the frequency-sharing radio communication system in the present embodiment, even when the satellite beams are reconstructed in such a manner, the monitoring device 24 can acquire, from the satellite dedicated terminal 31, the management information in which the frequencies used in the mobile base station 10 in which the satellite dedicated terminal 31 is disposed and the satellite beam information on the satellite beam that the satellite dedicated terminal receives are associated with each other. Thus, it is possible to stop the frequencies that are used by the mobile base station 10 in accordance with the changed satellite beam arrangement. Therefore, in the disaster-stricken area, the radio communication system in the frequency-sharing radio communication system preferentially uses the frequency band that is shared with the mobile phone system.

Moreover, because the spot of the satellite beam 21d (frequency d) is not included in the disaster-stricken area, even when the mobile base station 10 in this spot uses the frequency d, the mobile base station 10 is not instructed to stop using the frequency d and thus the mobile phone system can continuously use the frequency d in the same manner as normal.

The satellite dedicated terminal 31 explained in the present embodiment may have a function of another radio communication system. The managing device 15 and the monitoring device 24 may be configured into an integrated device.

In the present embodiment, the satellite dedicated terminal 31 reports, to the monitoring device 24, the usage state of the frequencies used by the mobile base station 10; however, when the satellite dedicated terminal 31 that monitors the state of the power supply 103 determines that power is not supplied from the power supply 103, the satellite dedicated terminal 31 can determine that the operation of the mobile base station 10 has stopped.

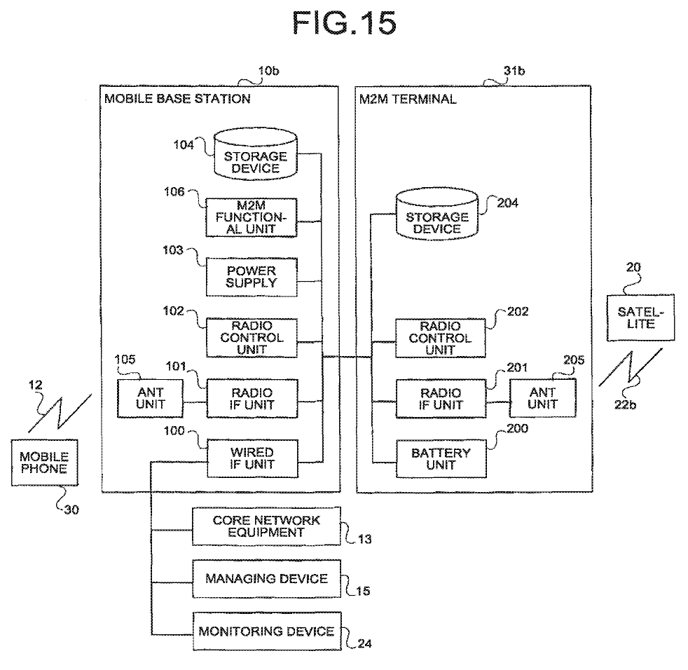

In the explanation of the above first embodiment, the satellite dedicated terminal 31 reports the operational state of the mobile base station 10 to the monitoring device 24; however, as in a satellite dedicated terminal 31b and a mobile base station 10b illustrated in FIG. 15, the configuration may be changed such that the mobile base station 10b includes an M2M functional unit 106, the M2M functional unit 106 of the mobile base station 10b may acquire the satellite beam information from the satellite dedicated terminal 31b, and the mobile base station 10b itself may report the operational state of the mobile base station 10b to the monitoring device 24. In such a case, the monitoring device 24 can acquire the operational information by appropriately changing the sequence explained in the first embodiment. Moreover, in such a case, the satellite communication line that is used for the monitoring device 24 to acquire the operational state is not necessary; therefore, it is not necessary to perform a call connection on the satellite communication system.

As described above, with the frequency-sharing radio communication system according to the present embodiment in which the terrestrial radio communication system and the satellite communication system share a frequency, the monitoring device 24 acquires the frequency of the radio wave of the satellite communication system radiated to the position of a base station in the terrestrial radio communication system, the base station of the terrestrial radio communication system, and the usage state of the frequencies of the radio waves used by this base station, and stores the management information that manages these pieces of information in association with each other, and the managing device 15 acquires the management information from the monitoring device 24. When a base station of a terrestrial communication system uses the same frequency as the beam radiated to the spot of the satellite communication system in which the base station is located, the use of the frequency is stopped (inhibited) in the base station; therefore, it is possible to use the inhibited frequency in a terrestrial radio communication system that is located in a spot of a beam that uses a frequency different from that of the aforementioned beam. Therefore, it is possible to improve the frequency use efficiency in the frequency-sharing radio communication system.

### INDUSTRIAL APPLICABILITY

As described above, the frequency-sharing radio communication system and the satellite terminal according to the present invention can improve the frequency use efficiency in a radio communication system in which a terrestrial radio communication system and a satellite communication system share a frequency.

### REFERENCE SIGNS LIST

10 mobile base station, 11 service area of mobile phone system, 12 terrestrial radio signal, 13 core network equipment, 15 managing device, 20 satellite, 21 service area of satellite communication system, 22a satellite radio signal on feeder link, 22b satellite radio signal on service link, 23 satellite base station, 24 monitoring device, 30 mobile terminal, 31 satellite dedicated terminal, 100 wired IF unit, 101 radio IF unit, 102 radio control unit, 103 power supply, 104 storage unit, 105 ANT unit (antenna), 106 M2M functional unit, 200 battery unit, 201 radio IF unit, 202 radio control unit, 203 M2M functional unit, 204 storage unit, 205 ANT unit (antenna).

1. A frequency-sharing radio communication system that includes a terrestrial radio communication system and a satellite communication system and in which a frequency band of a radio wave used by a terrestrial base station and a radio terminal of the terrestrial radio communication system overlaps with a frequency band of a radio wave (hereinafter, referred to as a beam) radiated from a satellite of the satellite communication system, the frequency-sharing radio communication system comprising:
a monitoring device that stores management information in which a frequency used by the terrestrial base station, an usage state of the frequency, and a frequency of the beam radiated to an area where the terrestrial base station is located are associated with each other; and
a managing device that selects, on a basis of the management information acquired from the monitoring device, the terrestrial base station that shares a frequency with the beam and is located within an irradiation range of the beam, and gives an instruction to stop using the shared frequency to the selected terrestrial base station.

2. The frequency-sharing radio communication system according to claim 1, further comprising a satellite terminal that is installed in the terrestrial base station; includes an antenna that receives the beam radiated from the satellite of the satellite communication system and transmits a radio wave to the satellite; and notifies the monitoring device, via a satellite communication line of the satellite communication system, of a frequency used by the terrestrial base station and an usage state of the frequency, the frequency and the usage state of the frequency being acquired from the terrestrial base station.

3. The frequency-sharing radio communication system according to claim 1, wherein the managing device acquires the management information on the terrestrial base station located in a disaster-stricken area when a disaster occurs, and gives the instruction to the terrestrial base station in the disaster-stricken area.

4. The frequency-sharing radio communication system according to claim 3, wherein the managing device detects a number of terrestrial base stations that stop using a frequency on a basis of the management information on the terrestrial base station located in the disaster-stricken area, the management information being acquired from the terrestrial base station, and determines whether to give the instruction on a basis of the detected number of terrestrial base stations and a disaster mode switching threshold that is a reference for determining a scale of a disaster.

5. A satellite terminal that is installed in a terrestrial base station of a terrestrial radio communication system that is used in a frequency-sharing radio communication system that includes the terrestrial radio communication system and a satellite communication system and in which a frequency band of a radio wave used by a terrestrial base station and a radio terminal of the terrestrial radio communication system overlaps with a frequency band of a radio wave (hereinafter, referred to as a beam) radiated from a satellite of the satellite communication system, the satellite terminal comprising:
an M2M functional unit that acquires a frequency used by the terrestrial base station and a usage state of the used frequency from the installed terrestrial base station; and
an antenna that outputs a radio wave for transmitting a satellite radio signal that includes the used frequency and the usage state of the frequency that are acquired by the M2M functional unit.
